(19) United States
(12) Patent Application Publication
(10) Pub. No.: US 2010/0169842 A1
(43) Pub. Date: Jul. 1, 2010

(54) Control Function Gestures

(75) Inventor: Charles J. Migos, San Francisco, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/347,733

(22) Filed: Dec. 31, 2008

(51) Int. Cl. G06F 3/033

(52) U.S. Cl. 715/863

(57) ABSTRACT

Techniques involving control function gestures are described. In an implementation, a control function is identified in response to gesture input at a touch screen of the remote control device. Execution of the identified control function is initiated a client device that is communicatively coupled to the remote control device and that is configured to alter an output of content by the client device that is broadcast to the client device.

### BACKGROUND

Remote control devices were developed to expand an ability of users to control content interaction by associated clients. For example, a client may be configured as a television to consume traditional broadcast content (e.g., television programming) and a traditional remote control device may be may be communicatively coupled to the television to initiate one or more control functions of the television. Therefore, a user may press buttons on the traditionally configured remote control device to increase or decrease volume of the television, change channels, select different sources for content, and so on. However, specific configuration of a remote control device for one set of users may make it less suited for another set of users.

### SUMMARY

Techniques involving control function gestures are described. In an implementation, a control function is identified in response to gesture input at a touch screen of the remote control device. Execution of the identified control function is initiated a client device that is communicatively coupled to the remote control device and that is configured to alter an output of content by the client device that is broadcast to the client device.

In an implementation, one or more computer readable tangible media include instructions that are executable by a remote control device to form a notification for communication to a client device to cause the client device to tune to a particular channel that were specified using a gesture be a touch screen of the remote control device.

In an implementation, a remote control device comprises a touch screen and one or more modules. The one or more modules are to detect one or more gestures that resemble one or more numbers input via the touch screen and determine a channel that correspond to the detected one or more gestures. The one or more modules are also configured to form a notification for wireless communication to a client device indicating that the client device is to tune to the determined channel.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques that involve control function gestures for a remote control device.

FIG. 2 depicts an example system showing a remote control device of FIG. 1 in greater detail as displaying representations of one or more control functions of a client that may be initiated through selection on the remote control device.

FIG. 3 depicts a system in an example implementation in which a gesture indicates a relative amount of an increase or a decrease in a value of a control function by a length of the gesture as applied to a touchscreen.

FIG. 4 depicts a system in an example implementation in which a gesture is utilized to initiate a control function that relates to a personal video recorder (PVR).

FIG. 5 is a flow diagram depicting a procedure in an example implementation in which a gesture is utilized to initiate execution of a control function by a client.

FIG. 6 is a flow diagram depicting a procedure in an example implementation in which a gesture is utilized to specify a particular channel and another gesture is utilized to implement a trick mode.

### DETAILED DESCRIPTION

Overview

Techniques related to control function gestures are described. In an implementation, a remote control device includes functionality to detect and identify gestures received via a touch surface (e.g., touch screen, touch pad, and so on) of the remote control device. The gestures may relate to control functions of the client device that is communicatively coupled to the remote control device, e.g., a television.

For example, a gesture may be received via a touch screen of the remote control device that resembles one or more numbers, such as by dragging a finger or stylus by a user across a surface of the touch screen to mimic the one or more numbers. The one or more numbers may then be used to cause the client device (e.g., a television) to tune to a channel that corresponds to the one or more numbers. Thus, a user may provide an intuitive input by “drawing” a number of a desired channel on a remote control device. A variety of other control functions may also be initiated using gestures, such as to increase or decrease volume, initiate a recording of content to a personal video recorder, and so on, further discussion of which may be found in relation to the following sections.

In the following discussion, an example environment and systems are first described that is operable to perform techniques that relate to control function gestures Example procedures are then described that may be employed in the example environment, as well as in other environments. Although control function gestures is described in a television environment in the following discussion, it should be readily apparent that the gestures may be employed in a wide variety of environments without departing from the spirit and scope thereof such as for other broadcast environments such as terrestrial and non-terrestrial radio.

Example Environment

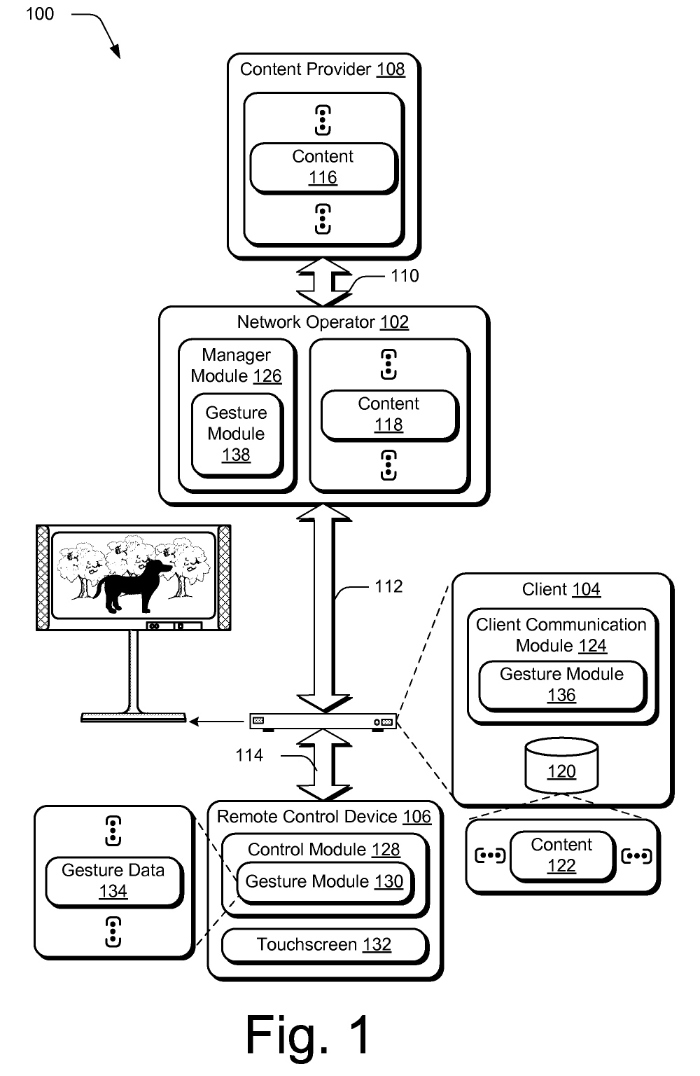

FIG. 1 is an illustration of an environment 100 in an example implementation that is operable to employ techniques relating to control function gestures. The illustrated environment 100 includes a network operator 102 (e.g., a “head end”), a client 104, a remote control device 106 and a content provider 108 that are communicatively coupled, one to another, via network connections 110, 112, 114. In the following discussion, the network operator 102, the client 104, the remote control device 106 and the content provider 108 may be representative of one or more entities, and therefore by convention reference may be made to a single entity (e.g., the client 104) or multiple entities (e.g., the clients 104, the plurality of clients 104, and so on).

Additionally, although a plurality of network connections 110-114 are shown separately, the network connections 110-114 may be representative of network connections achieved using a single network or multiple networks, e.g., network connections 110, 112 may be implemented via the internet and network connection 114 may be implemented via a local network connection, such as via infra red, a radio frequency connection, and so on. In another example, network connection 114 may also be implemented via the internet.

The client 104 may be configured in a variety of ways. For example, the client 104 may be configured as a computer that is capable of communicating over the network connections 112, 114, such as a television, a mobile station, an entertainment appliance (e.g., a game console), a set-top box communicatively coupled to a display device as illustrated, and so forth. Thus, the client 104 may range from a full resource device with substantial memory and processor resources (e.g., television-enabled personal computers, television recorders equipped with hard disk) to a low-resource device with limited memory and/or processing resources (e.g., traditional set-top boxes).

Communication of content to the client 104 may be performed in a variety of ways. For example, the client 104 may be communicatively coupled to the content provider 108 (which may be representative of one or more content providers) using a packet-switched network, e.g., the Internet. Accordingly, the client 104 may receive one or more items of content 116, broadcast directly from the content provider 108. The content 116 may include a variety of data, such as television programming, video-on-demand (VOD) files, and so on. A variety of other examples are also contemplated, such as by using an indirect distribution example in which the content 116 is communicated over the network connection 110 to the network operator 102.

For example, content 116 may be communicated via the network connection 110 to the network operator 102 and stored as one or more items of content 118. The content 118 may be the same as or different from the content 116 received from the content provider 108. The content 118, for instance, may include additional data for broadcast to the client 104. For example, the content 118 may include electronic program guide (EPG) data from an EPG database for broadcast to the client 104 utilizing a carousel file system and an out-of-band (OOB) channel. Distribution from the network operator 102 to the client 104 over network connection 112 may be accommodated in a number of ways, including cable, radio frequency (RF), microwave, digital subscriber line (DSL), and satellite.

The client 104, as previously stated, may be configured in a variety of ways to receive the content 118 over the network connection 114. The client 104 typically includes hardware and software to transport and decrypt content 118 received from the network operator 102 for output to and rendering by the illustrated display device. Although a display device is shown, a variety of other output devices are also contemplated that may be substituted or added to the display device, such as speakers. Further, although the display device is illustrated separately from the client 104, it should be readily apparent that the client 104 may also include the display device as an integral part thereof.

The client 104 may also include personal video recorder (PVR) functionality. For instance, the client 104 may include a storage device 120 to record content 118 as content 122 received via the network connection 112 for output to and rendering by the display device. The storage device 120 may be configured in a variety of ways, such as a hard disk drive, a removable computer-readable medium (e.g., a writable digital video disc), and so on. Thus, content 122 that is stored in the storage device 120 of the client 104 may be copies of the content 118 that was streamed from the network operator 102. Additionally, content 122 may be obtained from a variety of other sources, such as from a computer-readable medium that is accessed by the client 104, and so on. For example, content 122 may be stored on a digital video disc (DVD) when the client 104 is configured to include DVD functionality.

The client 104 includes a client communication module 124 that is representative of functionality of the client 104 to control content interaction on the client 104, such as through the use of one or more “control functions”. The control functions may include a variety of functions to control output of content, such as to control volume, change channels, select different inputs, configure surround sound, and so on. The control functions may also provide for “trick modes” that support non-linear playback of the content 122 (i.e., time shift the playback of the content 122) such as pause, rewind, fast forward, slow motion playback, and the like. For example, during a pause, the client 104 may continue to record the content 118 in the storage device 120 as content 122. The client 104, through execution of the client communication module 124, may then playback the content 122 from the storage device 120, starting at the point in time the content 122 was paused, while continuing to record the currently-broadcast content 118 in the storage device 120 from the network operator 102.

When playback of the content 122 is requested, the client communication module 124 retrieves the content 122. The client communication module 124 may also restore the content 122 to the original encoded format as received from the content provider 108. For example, when the content 122 is recorded on the storage device 120, the content 122 may be compressed. Therefore, when the client communication module 124 retrieves the content 122, the content 122 is decompressed for rendering by the display device.

The network operator 102 is illustrated as including a manager module 126. The manager module 126 is representative of functionality to configure content 11 8 for output (e.g., streaming) over the network connection 112 to the client 104. The manager module 126, for instance, may configure content 116 received from the content provider 108 to be suitable for transmission over the network connection 112, such as to “packetize” the content for distribution over the Internet, configuration for a particular broadcast channel, and so on.

Thus, in the environment 100 of FIG. 1, the content provider 108 may broadcast the content 116 over a network connection 110 to a multiplicity of network operators, an example of which is illustrated as network operator 102. The network operator 102 may then stream the content 118 over a network connection 112 to a multitude of clients, an example of which is illustrated as client 104. The client 104 may then store the content 118 in the storage device 120 as content 122, such as when the client 104 is configured to include personal video recorder (PVR) functionality, and/or output the content 118 directly.

The remote control device 106 is illustrated as including a control module 128 that is representative of functionality to control operation of the remote control device 106 and/or the client 104 via the network connection 114. Thus, the control module 128 is also representative of functionality to initiate control functions of the client 104. For example, the control module 128 may be configured to receive inputs related to selection of representations of control functions, such as a selection of a “volume up” representation on the remote control device 106 using a button. Data indicating this selection may then be communicated via network connection 114 to the client 104 that causes the client 104 (e.g., the client's 104 communication module 124) to increase the volume. A variety of other control functions may also be initiated by the control function module 128 as previously described.

The control module 128 is further illustrated as including a gesture module 130 that is representative of functionality relating to gestures input at the remote control device 106. The gesture module 130, for instance, may detect a gesture input at a touchscreen 132 (e.g., a capacitive touchscreen) of the remote control device 106. Although a touchscreen 132 is described, it should be readily apparent that a variety of different touch surfaces are contemplated, such as touch pads.

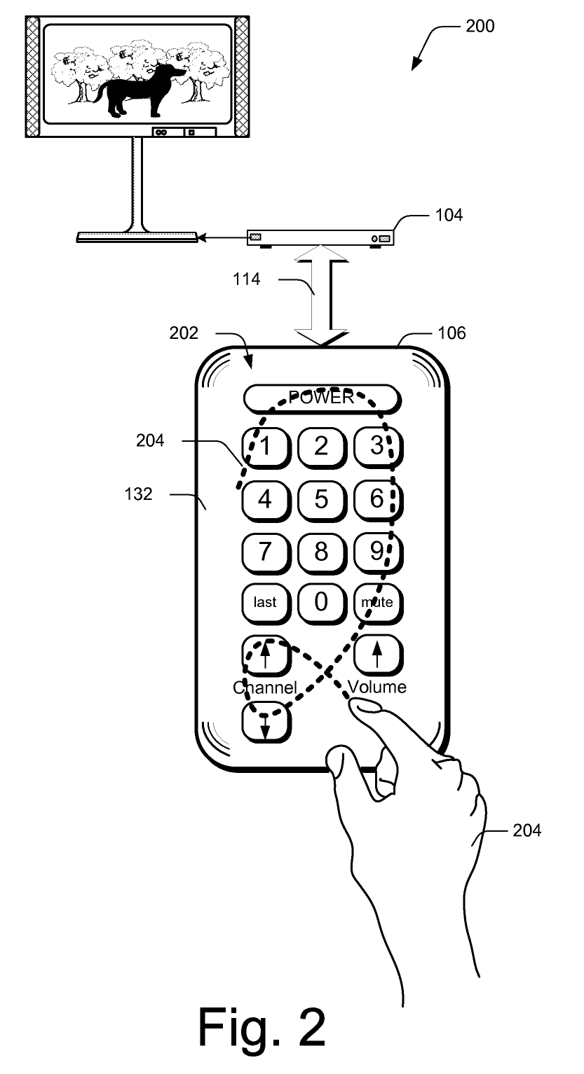

The gesture module 130 may then compare data representing the gesture with gesture data 134 to identify which of a plurality of control functions were intended to be initiated by a user. The gesture module 130 may then form a notification to be communicated to the client 104 via the network connection 114 to cause the control function to be initiated by the client 104. A variety of different control functions may be initiated using gestures, further discussion of which may be found in relation to FIGS. 2-4.

Although the remote control device 106 was described as including the functionality of the gesture module 130, this functionality may leverage the environment 100 in a variety of different ways. For example, the client 104 is illustrated as including a gesture module 136 that is representative of functionality that may be implemented by the client 104 that relates to gestures. Likewise, the network operator 102 (and more particularly the manager module 126) is also illustrated as including a gesture module 138 that is representative of functionality that may be implemented by the network operator 102 that relates to gestures.

For instance, the gesture module 130 of the remote control device 106 may receive an input of a gesture via the touchscreen 132. Data describing this input may be communicated to the client 104 and/or the network operator 102 for further processing, such as to identify which control function was likely intended by a user of the remote control device 106. The control function may then be initiated and/or performed, such as by communication of a notification from the network operator 102 to the client 104, performing the control function directly at the client 104 after identification of the gesture by the client 104, and so on. A variety of other examples are also contemplated, such as incorporation of gesture functionality at least in part by leveraging a stand-alone third party provider that is separate from the remote control device 106, network operator 102, and/or the client 104.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, e.g., as memory. The features of control function gesture techniques described below are platform-independent, meaning that the techniques may be implemented on a variety of commercial computing platforms having a variety of processors.

FIG. 2 depicts an example system 200 showing the remote control device 106 in greater detail as displaying representations 202 of one or more control functions of the client 104 that may be initiated through selection on the remote control device 106. The illustrated remote control device 106 includes a touchscreen 132 that consumes approximately half of an outer surface of the remote control device 106 thereby giving the remote control device an appearance of a “glassy brick”.

In another implementation, the touchscreen 132 of the remote control device 106 covers at least forty percent of the outer surface of the remote control device 106. In a further implementation, the touchscreen 132 consumes, approximately, an outer surface of the remote control device 106 that is viewable by a user when placed on a surface (e.g., a top of a table) and/or grasped in a hand of the user, e.g., the illustrated outer surface of the remote control device 106 in FIG. 2. A variety of other implementations are also contemplated, such as implementations in which the touchscreen 132 of the remote control device 106 includes more or less than the previously described amounts of the outer surface of the remote control device 106.

A variety of different techniques may be used to detect input by the touchscreen 132, such as through resistive techniques, surface acoustic waves, capacitive, infrared, use of strain gauges, optical imaging, dispersive signal technology, acoustic pulse recognition, frustrated total internal reflection, and so on. Using these techniques, the remote control device 106 may detect one or more inputs (e.g., multi-touch) that may be used to initiate one or more control functions.

For example, by selecting one or more of the representations 202, a user may supply an input to initiate the represented control function by the client 104. As illustrated by the remote control device 106 of FIG. 2, for instance, a user may select a “power” representation, one or more numbers to select a channel, “mute”, “last”, “channel up”, “channel down”, “volume up”, “volume down” and “input select”. Thus, the remote control device 106 may communicate with the client 104 to control output of content by the client 104.

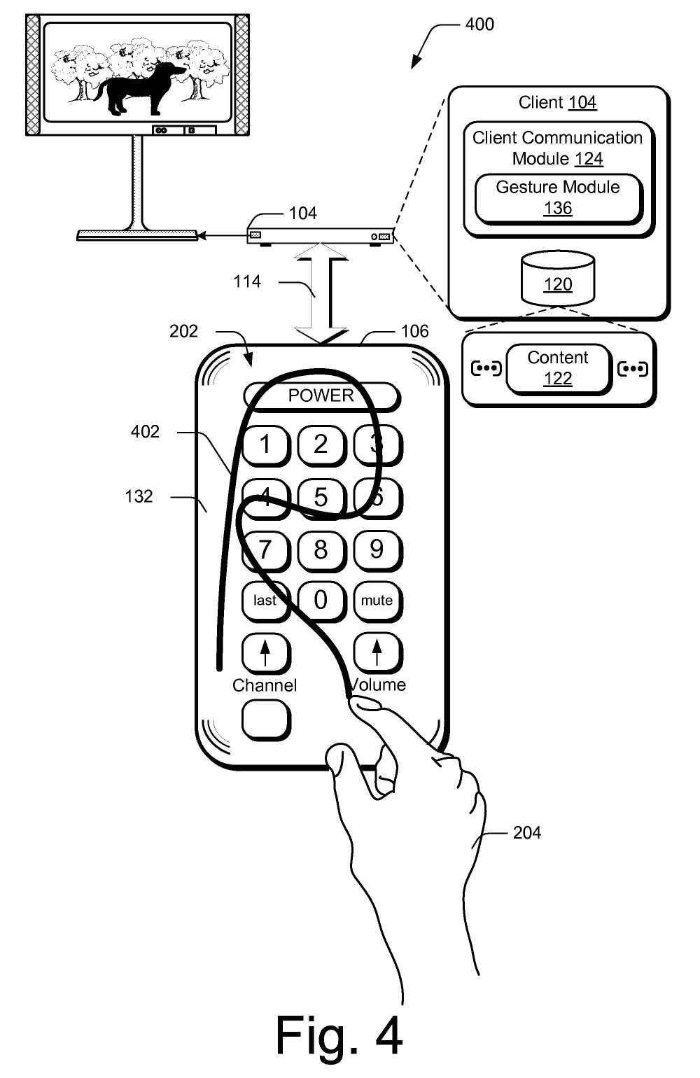

The remote control device 106 of FIG. 2 may also include functionality to recognize gestures via the touchscreen 132. For example, a user's hand 204 is illustrated as making a numeric gesture that resembles a number “2”. The gesture is illustrated in phantom lines in FIG. 2 to indicate that an output is not provided by the touchscreen 132 in this example that follows input of the gesture. In another example, an output is provided that follows input of the gesture, further discussion of which may be found in relation to FIG. 4.

In this example, input of a gesture that corresponds to a number may be automatically recognized by the gesture module 130 of the remote control device 106 as corresponding to a channel number. Accordingly, the gesture module 130 in conjunction with the control module 128 of the remote control device 106 may form a notification. The notification may be communicated via the network connection 114 to the client 104 to initiate a control function of the client 104 to tune to a channel that corresponds to the number input via the gesture, which in this instance is channel “2”.

Additionally, a plurality of numbers may also be entered via the touchscreen 132 of the remote control device 106. Continuing with the previous example, a user may make a gesture of a number “2” followed by a numeric gesture of a number “9” to cause the client 104 to tune to channel 29. In this example, the gesture module 130 includes a threshold such that successive inputs received via the touchscreen 132 of the remote control device 106 are considered to designate a single channel as opposed to multiple channels.

It should be noted that in the illustrated system 200 of FIG. 2 representations of control functions are output concurrently as the gesture 206 is input by the user's hand 204. Using this functionality, a user of the remote control device 106 may initiate control functions that are not currently represented via the touchscreen 132, thus conserving an available display area of the touchscreen 132. A variety of other control functions may also be initiated using gestures, another example of which may be found in relation to the following figure.

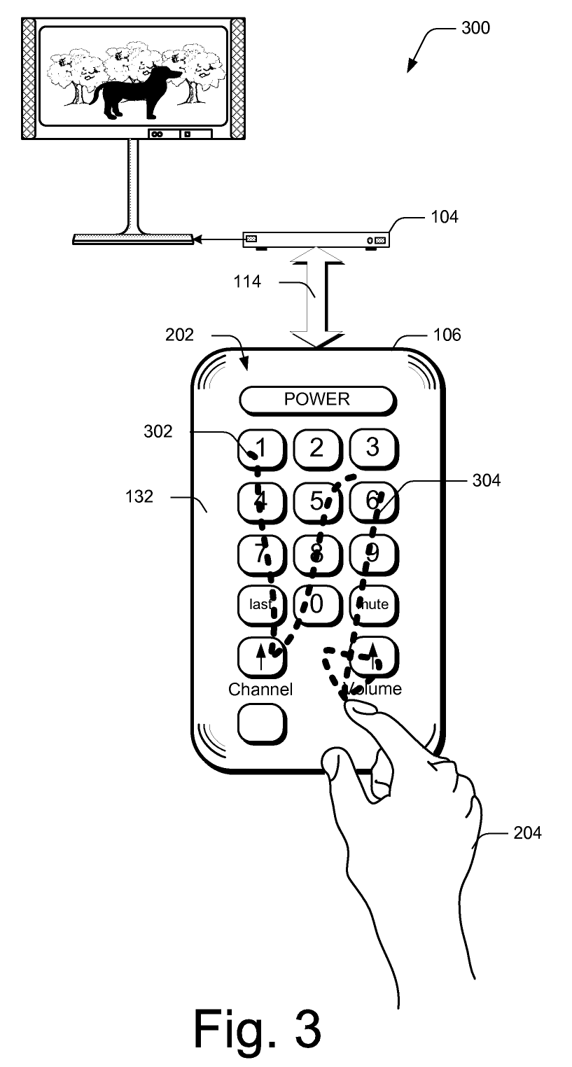

FIG. 3 depicts a system 300 in an example implementation in which a gesture indicates a relative amount of an increase or a decrease in a value of a control function by a length of the gesture as applied to the touchscreen 132. As before, the remote control device 106 includes a touch 8132 representations 202 of control functions. In the illustrated example of FIG. 3, two parts of the gesture are shown. A first part 302 of the gesture indicates a letter “V” and the second part 304 of the gesture indicates a down arrow. In this example, the gesture corresponds to a control function to decrease volume of an audio output of content.

The gesture indicated by the first and second parts 302, 304 may also indicate a relative amount of an increase or decrease of the corresponding control function. For instance, a length of the second part 304 of the gesture (i.e., the down arrow) may correspond to an amount that the volume is to decrease. In an implementation, this amount may be input in real-time such that the volume continues to decrease as a second part 304 of the gesture continues to be input. Thus, when the user reaches a desired level of volume, the user may cease input of the second part 304 of the gesture, e.g., by stopping input of the gesture. A variety of other control functions may also leverage this functionality, such as volume up, channel up and channel down (e.g., to scroll through channels), brightness, contrast, and so on.

FIG. 4 depicts a system 400 in an example implementation in which a gesture is utilized to initiate a control function that relates to a personal video recorder (PVR). In the illustrated example, the remote control device is communicatively coupled to the client 104 over network connection 114. The client 104 in this example includes functionality of a PVR. For example, the client 104 may employ the client communication module 124 and storage 120 to implement one or more trick modes, such as to pause an output of content received by the client 104 as previously described.

In the illustrated example in the system 400 of FIG. 4, a gesture 402 is input via a touchscreen 132 of a letter “R.” In the illustrated instance, the touchscreen 132 outputs an indication that follows input of the gesture 402 in real-time. In another instance, and the indication may be output when input of the gesture 402 is recognized as corresponding to a particular operation, e.g., one of the control functions as previously described.

For example, the letter “R” may be output when the gesture module 130 of the remote control device 106 recognizes that an input received via the touchscreen 132 corresponds to a record control function to be initiated by the client 104. A variety of other instances are also contemplated without departing from the spirit and scope thereof, such as to output a textual description that corresponds to the gesture (and consequently the control function such as to output text using a font that says “record” in the previous example), use of a confirmation screen (e.g., “do you want to record?”), and so on.

Example Procedures

The following discussion describes personalization techniques that may be implemented utilizing the previously described environment, systems, user interfaces and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and systems 200-400 of FIGS. 2-4, respectively.

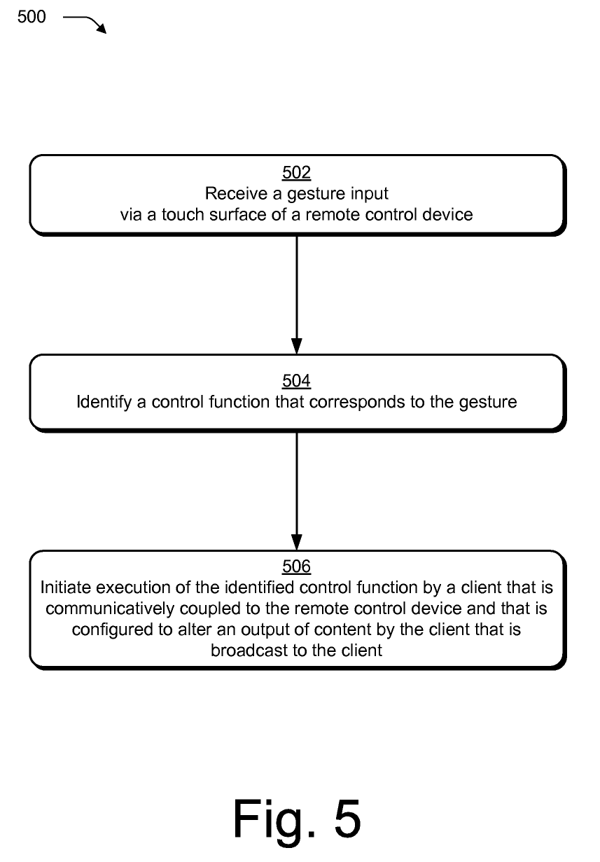

FIG. 5 depicts a procedure 500 in an example implementation in which a gesture is utilized to initiate execution of a control function by a client. A gesture is received that was input via a touch surface of a remote control device (block 502). For example, the gesture may be received via the touchscreen 132 of the remote control device 106 as previously described, a touch pad, and so on.

A control function is identified that corresponds to the gesture (block 504). Execution of the identified control function by a client that is communicatively coupled to the remote control device is initiated, the remote control device being configured to alter an output of content by the client that is broadcast to the client (block 506). For example, the gesture may correspond to a control function such as a channel change control function, a volume control function, brightness, contrast, and so on.

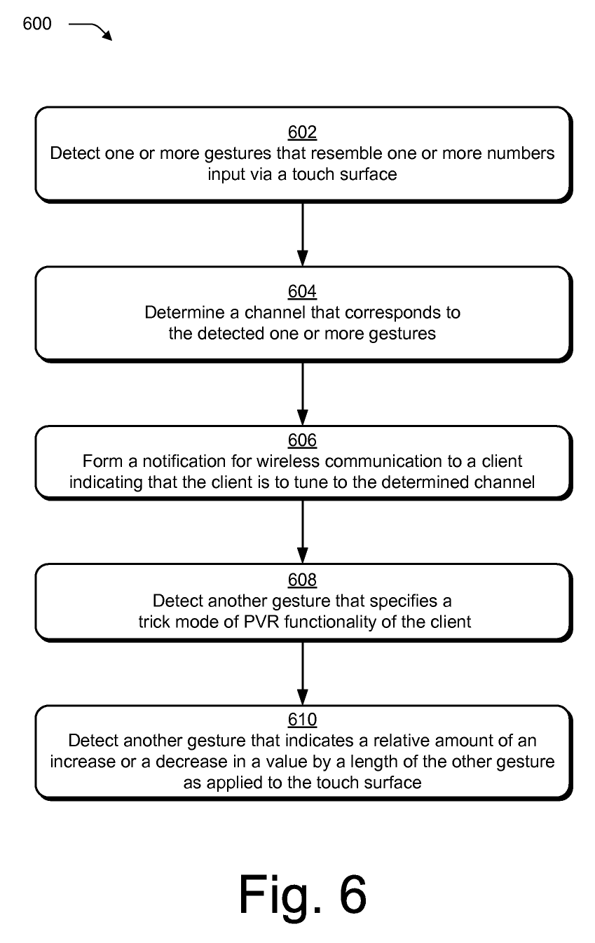

FIG. 6 depicts a procedure 600 in an example implementation in which a gesture is utilized to specify a particular channel and another gesture is utilized to implement a trick mode. One or more gestures are detected that resemble one or more numbers input via a touch screen (block 602). For example, the gestures and the numeric gestures that are input in a manner that mimics how the numbers would be input when written manually by a user.

A channel is determined that corresponds to the detected one or more gestures (block 604). For example, the gesture module 130 may determine which numbers were likely input using gestures via the touchscreen 132 of the remote control device 106.

A notification is formed for wireless communication to a client indicating that the client is to tune to the determined channel (block 606). For example, the notification may be formed for communication over a local wireless connection to the client. A variety of other control functions must be initiated using a gesture.

For example, another gesture may be detected that specifies a trick mode a PVR functionality of the client (block 608). For instance, the client 104 may output content received via a network operator 102, a user wishing to record the content 118 to storage 120 as content 122 may make a gesture (e.g., the “R” of FIG. 4) to cause the content to be recorded. In another example, another gesture may be detected that indicates a relative amount of an increase or decrease in a value by a length of the other gesture as applied to the touchscreen (block 610), instances of which were previously described in relation to FIG. 4.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
identifying a control function that corresponds to a gesture input via a touch surface of a remote control device; and
initiating execution of the identified control function by a client device that is communicatively coupled to the remote control device and that is configured to alter an output of content by the client device that is broadcast to the client device.

2. A method as described in claim 1, wherein the control function includes functionality to select a particular one of a plurality of channels in the broadcast.

3. A method as described in claim 2, wherein the gesture is a numeric gesture that indicates input of one or more numbers.

4. A method as described in claim 1, wherein the gesture indicates a relative amount of an increase or a decrease in a value by a length of the gesture as applied to the touch surface.

5. A method as described in claim 4, wherein the increase or decrease relates to volume of audio of the content output by the client device.

6. A method as described in claim 1, wherein the execution of the control function changes how the content is rendered by the client device for output.

7. A method as described in claim 1, wherein the client device includes personal video recorder (PVR) functionality and the control function involves a trick mode of the PVR functionality.

8. A method as described in claim 1, wherein the client device is a television.

9. A method as described in claim 1, wherein the identifying and the initiating are performed by the remote control device.

10. One or more computer-readable tangible media comprising instructions that are executable by a remote control device to form a notification for communication to a client device to cause the client device to tune to a particular channel that was specified using a gesture via a touch surface of the remote control device.

11. One or more computer-readable media as described in claim 10, wherein the gesture is a numeric gesture that resembles a number of the particular channel.

12. One or more computer-readable media as described in claim 10, wherein the gesture is received during concurrent output of representations of control functions via the touch surface.

13. One or more computer-readable media as described in claim 10, wherein the particular channel is configured to output one or more television programs received at the client device via a broadcast.

14. One or more computer-readable media as described in claim 10, wherein the remote control device is configured to communicate the notification to the client device over a local wireless network connection.

15. A remote control device comprising:
a touch surface; and
one or more modules to:
detect one or more gestures that resemble one or more numbers input via the touch surface;
determine a channel that corresponds to the detected one or more gestures; and
form a notification for wireless communication to a client device indicating that the client device is to tune to the determined channel.

16. A remote control device as described in claim 15, wherein:
the client device is a set-top box that is configured to tune to the determined channel to receive content via a broadcast; and
the touch surface is a touchscreen or touch pad.

17. A remote control device as described in claim 15, wherein the client device includes personal video recorder (PVR) functionality and the one or more modules are further configured to detect another gesture that specifies a trick mode of the PVR functionality.

18. A remote control device as described in claim 15, wherein the one or more modules are further configured to detect another gesture that indicates a relative amount of an increase or a decrease in a value by a length of the other gesture as applied to the touch surface.

19. A remote control device as described in claim 18, wherein the increase or decrease relates to volume of audio of the content output by the client device.

20. A remote control device as described in claim 15, wherein the one or more modules are further configured to detect another gesture that changes how the content is rendered by the client device for output.
